(19) United States
(12) Patent Application Publication
(10) Pub. No.: US 2025/0108551 A1
(43) Pub. Date: Apr. 3, 2025

(54) METHOD FOR MANUFACTURING AN INTERMEDIATE RESISTIVE MEMBRANE OF AN ACOUSTIC COATING

(71) Applicant: Airbus Operations SAS, TOULOUSE (FR)

(72) Inventors: Laurent CAZEAUX, TOULOUSE (FR); Laurent CALIMAN, TOULOUSE (FR); Nicolas CHARTON, TOULOUSE (FR)

(21) Appl. No.: 18/897,563

(22) Filed: Sep. 26, 2024

(30) Foreign Application Priority Data
Sep. 28, 2023 (FR) 2310365

(51) Int. Cl. B29C 51/08; B29C 51/12; B29C 51/14; B29K 101/12; B29K 105/06

(52) U.S. Cl. CPC B29C 51/082; B29C 51/12; B29C 51/14; B29K 2101/12; B29K 2105/06; B29K 2995/0097

(57) ABSTRACT

A method for manufacturing an intermediate resistive membrane called “septum” with tubular guides for an acoustic treatment panel with double degree of freedom. The membrane and the tubular guides are manufactured by hot stamping a substrate placed between two parts of a stamping press and an additional layer taking the form of a thermoplastic film of small thickness and pre-perforations. Hot air intake may be used for the hot stamping.

### CROSS-REFERENCES TO RELATED APPLICATIONS

This application claims the benefit of French Patent Application Number 2310365 filed on Sep. 28, 2023, the entire disclosure of which is incorporated herein by way of reference.

### FIELD OF THE INVENTION

The invention relates to a method for manufacturing an intermediate resistive membrane, called “septum”, of an acoustic panel said to be with double degree of freedom. The invention relates more particularly to a method for manufacturing a membrane of septum type comprising a plurality of integrated tubular guides, for the manufacturing of an aircraft acoustic panel.

### BACKGROUND OF THE INVENTION

Acoustic panels (or coatings) of double degree of freedom (DDOF) type are known. These acoustic panels apply acoustic treatments aiming to reduce an incident soundwave directed towards a face of such a panel. These acoustic panels comprise two cellular (most often of honeycomb type) webs (layers) superposed and separated by an intermediate resistive layer called “septum”, which intermediate layer comprises openings and comprises a multitude of tubular guides, each of which is often associated with a pair of cellular cells belonging respectively to one and the other of the two cellular webs. The cellular cells of such a pair are arranged facing one another, but are not necessarily fully centered with respect to one another and several tubular guides can be implemented for such a pair of cellular cells. Such acoustic panels of DDOF type are notably, but not solely, used in walls of aircraft nacelles or in jet engine casings. Many elements are assembled for the manufacturing of an acoustic panel or coating of DDOF type including the intermediate resistive membrane, comprising openings, and the tubular guides (tubes) assembled in or around these openings. Generally, and according to the characteristics sought, the “septum” intermediate membrane is made of glass, which facilitates the layout of the tubes by virtue of the transparency of the glass, on or in which tubular guides made of polymer material are assembled by means of a robot and sealed, making the manufacturing of the assembly complex, difficult and costly.

The situation can be improved.

### SUMMARY OF THE INVENTION

One object of the present invention is to improve the conditions for manufacturing an intermediate resistive membrane of an acoustic panel by reducing the number of steps required in order to simplify and accelerate the manufacturing process and reduce the cost thereof.

To this end, a method is proposed for manufacturing an intermediate resistive membrane with tubular guides for an acoustic panel, the method being characterized in that said membrane and said tubular guides are formed in an operation of hot stamping of a substrate placed between two parts of a stamping press, said press being such that one of the two parts of the press comprises a plurality of protuberances each having a surface of a form complementing a form of an inner surface of said tubular guides and the other of said two parts of said press comprises a plurality of cavities each having a surface of a form complementing a form of an outer surface of said tubular guides.

Advantageously, the manufacturing of a “septum” resistive membrane for an acoustic treatment panel or coating is simplified and made more reliable, and its cost is reduced.

The method for manufacturing an intermediate resistive membrane with tubular guides for an acoustic panel according to the invention can further comprise the following features considered alone or in combination.

The substrate used according to the method is made of thermoplastic material.

The thermoplastic material in which the substrate is produced comprises fibers called “short fibers”, fibers called “long fibers” or fibers called “continuous fibers”.

The substrate used is covered with an additional layer that takes the form of a thermoplastic film said to be of small thickness.

The thermoplastic film has a thickness less than or equal to 0.2 mm.

The thermoplastic film affixed to the substrate is filled with fibers called short fibers.

The substrate and the additional layer are pre-perforated prior to the hot stamping operation.

The substrate and the additional layer are respectively pre-perforated in two mutually independent drilling operations.

The hot stamping operation comprises an intake of hot air via intake channels opening at the top of said protuberances of the stamping press.

### BRIEF DESCRIPTION OF THE DRAWINGS

The features of the invention mentioned above, and others, will become more clearly apparent on reading the following description of an exemplary embodiment, said description being given in relation to the attached drawings:

FIG. 1 illustrates an intermediate resistive membrane of septum type of an acoustic panel of DDOF type manufactured according to one embodiment;

FIG. 2 schematically illustrates a substrate of material positioned in a stamping press prior to manufacturing, by stamping, of the membrane represented in FIG. 1, according to one embodiment;

FIG. 3 schematically illustrates a substrate of material positioned in a stamping press according to a variant embodiment; and

FIG. 4 illustrates steps of the method for manufacturing a resistive intermediate membrane as represented in FIG. 1.

### DETAILED DESCRIPTION OF THE PREFERRED EMBODIMENTS

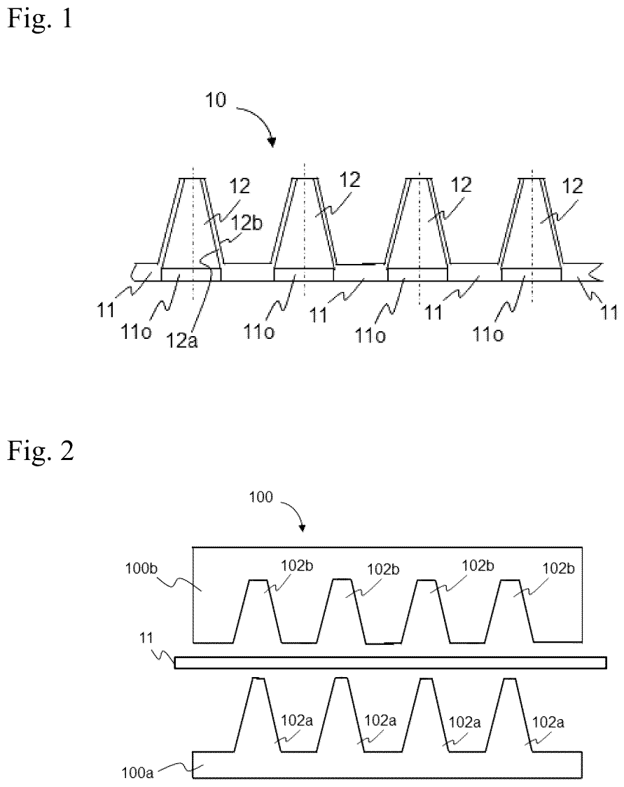

FIG. 1 schematically and symbolically represents an intermediate resistive membrane 10, called “septum”, arranged to separate two cellular webs of a same acoustic panel with double degree of freedom and manufactured by hot stamping according to an embodiment of the invention. The term “panel” here designates both an acoustic panel and an acoustic coating. The body of the intermediate resistive membrane 10 is made primarily from a substrate 11 shaped by hot stamping. According to one embodiment, the substrate 11 is produced in consolidated thermoplastic material that can include short fibers, long fibers or continuous fibers and takes the form of a sheet. The characteristics of these fibers are not detailed here inasmuch as a person of ordinary skill in the art will be able to choose the fibers to be used according to the final characteristics sought.

According to one embodiment, the substrate 11 is coated with an additional layer that takes the form of a thermoplastic film of small thickness, filled or not with short fibers. This variant is used when an intake of hot air is produced during the operation of hot stamping of the substrate 11. Advantageously, the resistive membrane 10 comprises a plurality of tubular guides 12, the purpose of which is to each serve as Helmholtz resonator neck after the assembly of a panel or coating of DDOF type. In other words, the tubular guides 12 are Helmholtz resonator necks.

According to a nonlimiting embodiment of the invention, the tubular guides 12 each have a frustoconical or substantially frustoconical form. Perforations of the tops of the tubular guides 12 are produced during the hot stamping, in order to then assemble the tubular guides 12 as Helmholtz resonator necks, each facing a first cell of a first cellular web of an acoustic panel, on the one hand, and facing a second cell of a second cellular web of the same acoustic panel, on the other hand. The tubular guides 12 each have an outer surface 12b and an inner surface 12a shaped by hot stamping in a stamping tool 100, also called stamping press 100 (represented in FIG. 2). More generally, the resistive membrane 10 as a whole is shaped in a hot stamping operation possibly preceded by a pre-perforation (or punching) operation for the purposes of creating beginnings of cuts in the substrate 11 which is then coated with an additional layer in the form of a thermoplastic film of small thickness. The resistive membrane 10 has through-openings 11o obtained by stamping, and forming the base of the tubular guides 12.

FIG. 2 schematically represents a stamping press 100 configured to perform operations of hot stamping of the substrate 11 aiming to obtain the intermediate resistive membrane 10 in its final form after stamping. The stamping press 100 is configured for substrate 11 stamping operations. According to an exemplary embodiment, the stamping press 100 comprises an upper part 100b and a lower part 100a. The upper part 100b of the stamping press 100 comprises a plurality of cavities 102b and the lower part 100a of the stamping press 100 comprises a plurality of protuberances 102a. According to the exemplary embodiment described, each pair composed of a protuberance 102a and a cavity 102b is used for the shaping by stamping of one of the tubular guides 12 in the stamping press 100. The stamping press 100 is therefore arranged so that, in a substrate 11 stamping operation, and after activation of the stamping press 100 by bringing the parts 100a and 100b closer together, the substrate crushed in the remaining spaces, each defined between a protuberance 102a and a cavity 102b, creates the plurality of tubular guides 12 by deformation of the substrate 11 previously inserted into the stamping press 100. The bringing-together of the parts 100a and 100b of the stamping press is such that the crushing produced between the top of each protuberance 102a and the bottom of each cavity 102b crops the tubular guides 12 which then each have a through-opening that conforms to its Helmholtz resonator neck function. According to a variant embodiment, the substrate 11 is prepared before the hot stamping operation and before its introduction into the stamping press 100 by means of a preparation tool or of a second stamping press, calibrated to produce beginnings of openings (punching) or small openings, at the points which will be disposed facing protuberances 102a before the stamping operation. These beginnings of openings are also here called pre-perforations. According to this variant, the substrate comprises an additional layer that takes the form of a thermoplastic film of small thickness which will also be punched or pre-perforated, in order to be deformed then in a stream of hot air, at the same time as the substrate 11 will be hot-stamped, during a stamping operation in the stamping press 100.

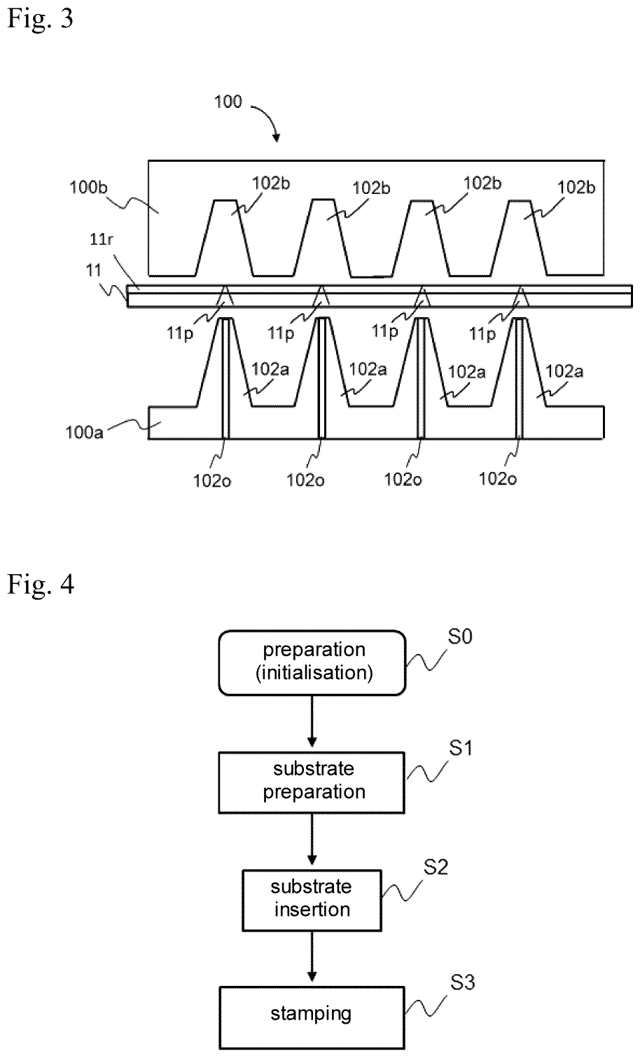

FIG. 3 illustrates a variant of the manufacturing method according to which the substrate 11 is coated with a thermoplastic film of small thickness 11r and is pre-perforated when it is placed in the stamping press 100. Pre-perforations 11p are then arranged in the substrate 11 before hot stamping in the stamping press 100. Furthermore, according to this variant, the lower part 100a of the stamping press 100 comprises hot air intake channels 102o configured to draw in hot air at a temperature T lying between 330° C. and 400° C. for the PEKK resin during the hot stamping operation by the stamping press 100. The temperature T is adjusted according to the material and the toolings used, as a function of the mechanical properties sought.

According to one embodiment, the stamping operation is applied in a mold heated to a temperature lying between 330° C. and 400° C. in order to obtain a vitreous state of the PEKK resin. The exact temperature of the mold is adjusted according to the type of resin used and according to the characteristics of the vitreous state sought. Thus, the temperature of the mold can vary as a function of the material and be different depending on whether the material is for example a resin of PEEK type, a PAEK resin, a PEI resin or a PEKK resin, these examples of course not being limiting. The characteristics of these resins are not detailed here in as much as the person skilled in the art will be able to choose a resin to be used as a function of the final characteristics sought. The type of resin used is chosen as a function of the targeted septum thickness, of the environmental conditions and of the temperatures of use of the septum that is produced.

FIG. 4 is a diagram illustrating a method for manufacturing an intermediate resistive membrane 10 according to an embodiment.

An initial step S0 is a method preparation step, also called initialization step, at the end of which all the material and/or human means are normally available and operational to execute the improved method for manufacturing the resistive membrane 10, according to an embodiment.

An optional step S1 of pre-perforation of a sheet of substrate not yet perforated is carried out to obtain pre-perforations (or beginnings of perforation) 11p in the substrate 11. This step S1 is necessary when the substrate is coated with a film, given the presence of the film; otherwise, in the absence of film, the substrate is directly stamped. According to one embodiment, the pre-perforations 11p are obtained by hot stamping using a secondary stamping tool (or press). According to a particular and nonlimiting embodiment, this hot stamping operation aiming to produce the pre-perforations is carried out in a heated secondary stamping press whose temperature is between 330° C. and 400° C., for example, for the PEKK resin and as a function of the toolings used. Such a stamping, using a heated secondary stamping press, makes it possible to apply a preforming of the perforated substrate 11, covered with an additional layer taking the form of a thermoplastic film of small thickness, before insertion into the stamping press 100, therefore before stamping by the stamping press 100.

The substrate is then placed in the stamping press 100 in a step S2, then the stamping operation is carried out in a step S3. In the stamping step S3, if the substrate 11 is not covered with the additional layer in the form of a thermoplastic film of small thickness 11r and there have been no pre-perforations 11p by means of a secondary stamping press in the step S1, then the hot stamping takes place without the intake of hot air. On the other hand, if the step S1 of preparation of the substrate 11 comprises the production of the pre-perforations 11p of the substrate 11 coated with an additional layer in the form of a thermoplastic film of small thickness 11r, then the stamping step S3 comprises an intake of a hot air stream by means of hot air intake channels 102o opening at the tops of the protuberances 102a of the part 100a of the stamping press 100. Advantageously, the hot air taken in is heated to a temperature lying between 330° C. and 400° C., for a PEKK resin and according to the toolings used, which makes it possible to obtain a weld by mixing between the substrate 11 and the tubular guides 12, which are then mainly obtained by deformation of the additional layer of resin.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for manufacturing an intermediate resistive membrane with tubular guides for an acoustic panel, the method comprising:
covering a substrate with an additional layer comprising a thermoplastic film, and,
forming an intermediate resistive membrane with tubular guides by hot stamping said substrate and said layer, said substrate and said layer being placed between two parts of a stamping press, wherein one of the two parts of the stamping press comprises a plurality of protuberances each having a surface form complementing an inner surface of said tubular guides and the other of the two parts of said press comprises a plurality of cavities each having a surface form complementing an outer surface of said tubular guides,
wherein said substrate and said additional layer are pre-perforated prior to the hot stamping.

2. The method according to claim 1, wherein said substrate comprises a thermoplastic material.

3. The method according to claim 1, wherein the substrate is filled with short fibers, long fibers, or continuous fibers.

4. The method according to claim 1, wherein a thickness of said thermoplastic film is less than or equal to 0.2 mm.

5. The method according to claim 1, wherein said substrate and said additional layer are respectively pre-perforated in two mutually independent perforation operations.

6. The method according to claim 1, wherein the hot stamping comprises an intake of hot air via intake channels opening at a top of said protuberances.
